(19) United States
(12) Patent Application Publication
(10) Pub. No.: US 2015/0205866 A1
(43) Pub. Date: Jul. 23, 2015

(54) PHRASE RESTRICTED SUBSTITUTE TERMS

(71) Applicants: Hayden Shaw, Palo Alto, CA (US); Robert B. Avery, Emeryville, CA (US); Trystan G. Upstill, Palo Alto, CA (US); Thomas Strohmann, Fremont, CA (US); Pi-Chuan Chang, Fremont, CA (US); John Blitzer, Mountain View, CA (US); P. Pandurang Nayak, Palo Alto, CA (US)

(72) Inventors: Hayden Shaw, Palo Alto, CA (US); Robert B. Avery, Emeryville, CA (US); Trystan G. Upstill, Palo Alto, CA (US); Thomas Strohmann, Fremont, CA (US); Pi-Chuan Chang, Fremont, CA (US); John Blitzer, Mountain View, CA (US); P. Pandurang Nayak, Palo Alto, CA (US)

(73) Assignee: GOOGLE INC., Mountain View, CA (US)

(21) Appl. No.: 13/485,731

(22) Filed: May 31, 2012

(51) Int. Cl. G06F 17/30

(52) U.S. Cl. CPC G06F 17/30864; G06F 17/3053; G06F 17/30312

(57) ABSTRACT

Methods, systems, and apparatus, including computer programs encoded on a computer storage medium, for retrieving documents. One of the methods includes receiving a search query that includes a first query term and an adjacent, second query term, and a substitute term for the first query term. A determination is made that the first query term and the substitute term satisfy one or more predetermined criteria and that a resource does not include the first query term. The resource is selected to be scored only if the substitute term occurs adjacent to the second term in the resource.

### BACKGROUND

This specification generally relates to search engines, and one particular implementation relates to selecting documents that are identified as being responsive to search queries.

### SUMMARY

Search systems use query revision engines to revise search queries, for example to include substitute terms of query terms. To identify a substitute term of a query term, query revisers evaluate candidate substitute terms according to various criteria, such as criteria that estimate whether, in a particular context, a candidate substitute term is a good substitute term of the query term. “Goodness” of a particular candidate substitute term may be expressed, for example, by the amount of confidence, trust, consistency, reliability, or other characteristic that defines an association between a query term and the candidate substitute term.

When obtaining search results using revised search queries that include substitute terms, however, a search engine may obtain search results based on an assumption that occurrences of all substitute terms of a query term are equivalent to, or “equally as good as,” occurrences of the query term. Such action may ignore the nuanced differences in confidence, trust, consistency, or reliability that a particular substitute term of the query term has in relation to a different substitute term.

Thus, according to one aspect of the subject matter described in this specification, substitute terms that satisfy certain criteria, e.g., reliability criteria, may be tagged or otherwise designated as phrase-restricted substitute terms, indicating that the phrase-restricted substitute terms' occurrence in relation to other query terms or other substitute terms in identified documents may affect whether or not the documents are retrieved as search results. The retrieval of such documents can be restricted by requiring particular substitute terms to occur adjacent to or near occurrences of other search query terms in a document. When search results are retrieved using a revised search query, documents that included a phrase-restricted substitute term may be retrieved using criteria that (i) is different than criteria that is used to retrieve documents including only query terms or highly-reliable substitute terms, and (ii) is informed by the fact that, with respect to a particular query term and a particular context, one substitute term may be more or less reliable than another substitute term.

In general, one innovative aspect of the subject matter described in this specification can be embodied in methods that include the actions of receiving (i) a search query that includes a first query term and an adjacent, second query term, and (ii) a substitute term for the first query term; determining that the first query term and the substitute term satisfy one or more predetermined criteria; determining that a resource does not include the first query term; and based on determining that the first query term and the substitute term satisfy the predetermined criteria and determining that the resource does not include the first query term, selecting the resource to be scored only if the substitute term occurs adjacent to the second term in the resource. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The actions further include determining that the resource does not include any other substitute term for the first query term, wherein selecting the resource to be scored is further based on determining that the resource does not include any other substitute term for the first query term. Determining that the first query term and the substitute term satisfy one or more predetermined criteria includes determining whether the first query term and the substitute term are morphological variants. Determining that the first query term and the substitute term satisfy one or more predetermined criteria includes determining whether the first query term and the substitute term are abbreviation or acronym variants. Determining that the first query term and the substitute term satisfy one or more predetermined criteria comprises identifying a substitution rule used to generate the substitute term and a confidence value associated with the substitution rule; and determining whether a confidence value associated with the substitution rule satisfies a threshold. Determining that the first query term and the substitute term satisfy one or more predetermined criteria includes determining whether the substitute term was identified using a specific-context substitution rule. Determining that the first query term and the substitute term satisfy one or more predetermined criteria includes determining a number of terms in the query, and determining that the number satisfies a threshold. Selecting a resource to be scored only if the substitute term occurs adjacent to the second term in the resource comprises identifying a plurality of resources that include the substitute term; and determining for each identified resource whether the substitute term occurs adjacent to the second term in the resource. The actions further include determining a score only for resources in which the substitute term occurs adjacent to the second term in the resource; and ranking the resources by score.

In general, another innovative aspect of the subject matter described in this specification can be embodied in methods that include the actions of receiving a first query term, a second query term, and a substitute term for the first query term; evaluating the first query term and the substitute term using one or more predetermined criteria; based on evaluating the first query term and the substitute term, selectively designating the substitute term as a phrase-restricted substitute term of the first query term, wherein substitute terms that are designated as phrase-restricted substitute terms must occur adjacent to the second query term in a resource that does not include the first query term for the resource to be selected to be scored in relation to a search query that includes the first query term and the second query term adjacent to the first query term. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. Evaluating the first query term and the substitute term using one or more predetermined criteria includes determining whether the first query term and the substitute term are morphological variants. Evaluating the first query term and the substitute term using one or more predetermined criteria includes determining whether the first query term and the substitute term are abbreviation or acronym variants. Evaluating the first query term and the substitute term using one or more predetermined criteria comprises identifying a substitution rule used to generate the substitute term and a confidence value associated with the substitution rule; and determining whether a confidence value associated with the substitution rule satisfies a threshold. Evaluating the first query term and the substitute term using one or more predetermined criteria includes determining whether the substitute term was identified using a specific-context substitution rule. Evaluating that the first query term and the substitute term satisfy one or more predetermined criteria includes determining a number of terms in the query, and determining that the number satisfies a threshold.

In general, another innovative aspect of the subject matter described in this specification can be embodied in methods that include the actions of receiving (i) a search query that includes a first query term and an adjacent, second query term, and (ii) a substitute term for the first query term; determining that the substitute term is designated as a phrase-restricted substitute term of the first term; in response to determining that the substitute term is designated as a phrase-restricted substitute term, determining that, in a resource that has been identified as responsive to the search query and that does not include the first query term, the substitute term occurs adjacent to the second query term; selecting the resource to be scored in relation to the search query only after determining that, in the resource that has been identified as responsive to the search query and that does not include the first query term, the substitute term occurs adjacent to the second query term. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. The actions further include determining that the resource does not include any other substitute term for the first query term, wherein selecting the resource to be scored is further based on determining that the resource does not include any other substitute term for the first query term. Selecting a resource to be scored only if the substitute term occurs adjacent to the second term in the resource comprises identifying a plurality of resources that include the substitute term; and determining for each identified resource whether the substitute term occurs adjacent to the second term in the resource. The actions further include determining a score only for resources in which the substitute term occurs adjacent to the second term in the resource; and ranking the resources by score.

Particular embodiments of the subject matter described in this specification can be implemented so as to realize one or more of the following advantages. Using different retrieval criteria for phrase-restricted substitute terms can improve the quality and relevance of provided search results. Identifying phrase-restricted substitute terms can also mitigate the identification of highly-irrelevant search results. Using different retrieval criteria for phrase-restricted substitute terms can also make retrieval more efficient by selecting fewer documents to be scored.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system that uses substitute terms to generate search results.

FIG. 2 is a diagram of an example system that uses retrieval criteria for phrase-restricted substitute terms to generate search results.

FIG. 3 is a flow chart of an example process for classifying a substitute term as a phrase-restricted substitute term.

FIG. 4 is a flow chart of an example process for retrieving a document identified using a search query revised to include a substitute term of a query term in the search query.

FIG. 5A illustrates retrieval of search results using example retrieval criteria that does not account for phrase-restricted substitute terms.

FIG. 5B illustrates retrieval of search results using example retrieval criteria that accounts for phrase-restricted substitute terms.

Like reference numbers and designations in the various drawings indicate like elements.

### DETAILED DESCRIPTION

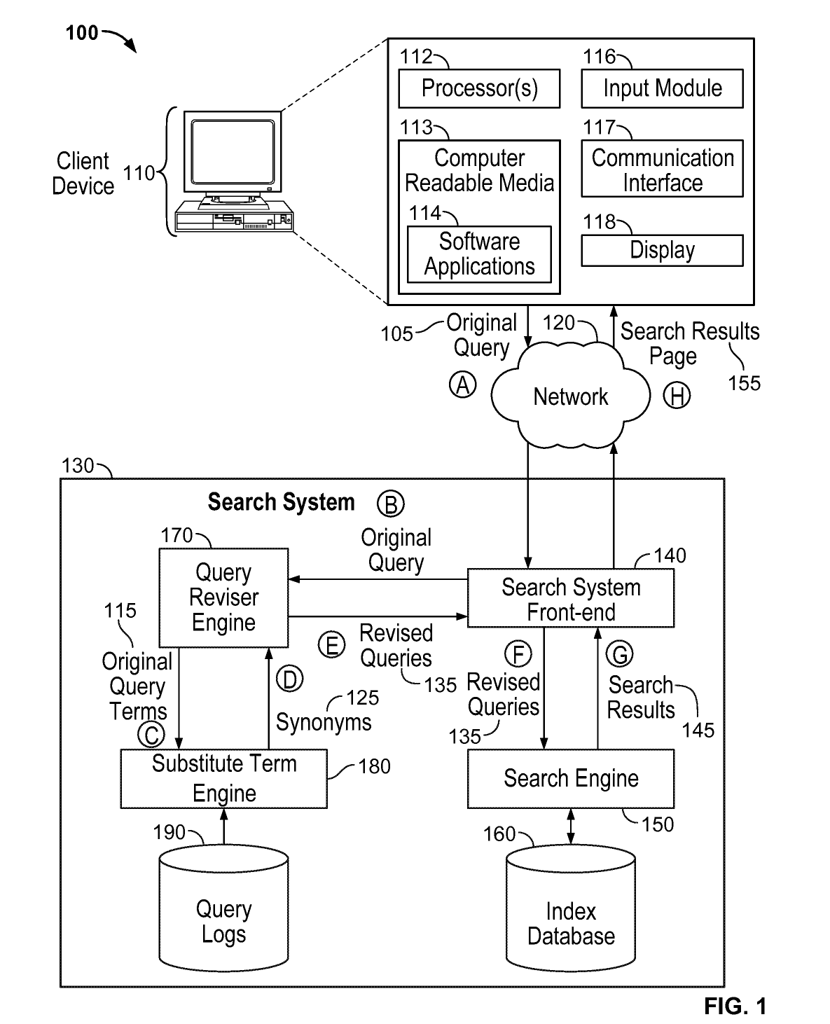

FIG. 1 is a diagram of an example system 100 that uses substitute terms to generate search results. In general, the system 100 includes a client device 110 coupled to a search system 130 over a network 120. The search system 130 includes a search engine 150, a query reviser engine 170, and a substitute term engine 180. The search system 130 receives a query 105, referred to by this specification as the “original query” or an “initial query,” from the client device 110 over the network 120. The search system 130 provides a search results page 155, which presents search results 145 identified as being responsive to the query 105, to the client device 110 over the network 120.

In some implementations, the search results 145 identified by the search system 130 can include one or more search results that are identified as being responsive to queries that are different than the original query 105. The search system 130 can generate or obtain other queries in numerous ways (e.g., by revising the original query 105).

In some implementations, the search system 130 can generate a revised query by adding to the original query 105 additional terms that are substitute terms of one or more terms that occur in the original query 105. In other implementations, the search system 130 can generate a revised query by substituting terms that are substitute terms of terms that occur in the original query 105, in place of the terms in the original query 105. As used by this specification, substitute terms, i.e., terms that are used to generate revised queries, are also referred to as “synonyms.” The substitute term engine 180 can identify the additional terms that are candidate substitute terms for the one or more terms that occur in the original query. The query reviser engine 170 can generate the revised query. The search engine 150 can use the original query 105 and the revised queries to identify and rank search results. The search engine 150 can provide the identified search results 145 to the client device 110 on the search results page 155.

The substitute term engine 180 can identify the substitute terms that the query reviser engine 170 can use to generate revised queries by evaluating terms included in previously received queries stored in a query logs database 190. The queries stored in the query logs database 190 can include previous queries where a user considered the results of the queries desirable. For example, the user can click the provided search results from a query, in effect, validating the search results. The queries stored in the query logs database 190 can include previous queries determined by the search system 130 as providing desirable results. For example, the search system 130 can perform a quality thresholding for returned search results from a query. The quality thresholding can include determining search results that have historically been returned for a particular query. Search results above the quality threshold can validate a query, which the search system 130 can then include in the query logs database 190.

For example, given a first term (“cat”), the substitute term engine 180 can evaluate terms (“feline” or “banana”) that are candidate substitute terms for the original term. In addition, the substitute term engine 180 can determine that certain terms are substitute terms of the first term (as in the case of “feline”), and that other terms are not substitute terms of the first term (as in the case of “banana”). The substitute term engine 180 can base this determination on rules stored in a substitution rules database 185. For example, a substitution rule can be “feline” is a substitute term for cat and “banana” is not a substitute term for cat.

The search system 130 can define substitution rules to apply generally, or to apply only when particular conditions, or query contexts, are satisfied. For example, the query context of a substitution rule can specify one or more other terms that should be present in the query for the substitution rule to apply. Furthermore, query contexts can specify relative locations for the other terms (e.g., to the right or left of a query term under evaluation). In another example, query contexts can specify a general location (e.g., anywhere in the query). For example, a particular substitution rule can specify that the term “pet” is a substitute term for the query term “dog,” but only when the query term “dog” is followed by the term “food” in the query. Multiple distinct substitution rules can generate the same substitute term for a given query term. For example, for the query term “dog” in the query “dog food,” the term “pet” can be specified as a substitute term for “dog” by both a substitution rule for “dog” in the general context and a substitution rule for “dog” when followed by “food.”

The substitution rules can depend on query contexts that define other terms in the original query 105. In other words, a substitution rule need not apply in all situations. For example, when the term “cats” is used as a single-term query, the term “felines” can be considered a substitute term for “cats”. The substitute term engine 180 can return the term “felines” to the query reviser engine 170 to generate a revised search query. In another example, when the query includes the term “cats” followed by the term “musical,” a substitution rule can specify that the term “felines” is not a substitute term for “cats.” In some implementations, the substitution rules can be stored in the substitution rules database 185 for use by the substitute term engine 180, the query reviser engine 170, or the search engine 150.

In the illustrative example of FIG. 1, the search system 130 can be implemented as computer programs installed on one or more computers in one or more locations that are coupled to each other through a network (e.g., network 120). The search system 130 includes a search system front end 140 (e.g., a “gateway server”) that coordinates requests between other parts of the search system 130 and the client device 110. The search system 130 also includes one or more “engines”: the search engine 150, a query reviser engine 170, and the substitute term engine 180.

As used in this specification, an “engine” (or “software engine”) refers to a software implemented input/output system that provides an output that is different from the input. An engine can be an encoded block of functionality, such as a library, a platform, a Software Development Kit (“SDK”), or an object. The network 120 can include, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination thereof.

The search system front-end 140, the search engine 150, the query reviser engine 170, and the substitute term engine 180 can be implemented on any appropriate type of computing device (e.g., servers, mobile phones, tablet computers, notebook computers, music players, e-book readers, laptop or desktop computers, PDAs, smart phones, or other stationary or portable devices) that includes one or more processors and computer readable media. Among other components, the client device 110 includes one or more processors 112, computer readable media 113 that store software applications 114 (e.g., a browser or layout engine), an input module 116 (e.g., a keyboard or mouse), a communication interface 117, and a display device 118. The computing device or devices that implement the search system front-end 140, the query reviser engine 170, and the search engine 150 may include similar or different components.

In general, the search system front-end 140 receives the original query 105 from the client device 110. The search system front-end 140 routes the original query 105 to the appropriate engines included in the search system 130 so that the search system 130 can generate the search results page 155. In some implementations, routing occurs by referencing static routing tables. In other implementations, routing occurs based on the current network load of an engine, in order to accomplish load balancing. In addition, the search system front-end 140 can provide the resulting search results page 155 to the client device 110. In doing so, the search system front-end 140 acts as a gateway, or interface, between the client device 110 and the search engine 150.

Two or more of a search system front-end, a query reviser engine and a search engine (e.g., the search system front-end 140, the query reviser engine 170, and the search engine 150, respectively) may be implemented on the same computing device, or on different computing devices. Because the search system 130 generates the search results page 155 based on the collective activity of the search system front-end 140, the query reviser engine 170, and the search engine 150, the user of the client device 110 may refer to these engines collectively as a “search engine.” This specification, however, refers to the search engine 150, and not the collection of engines, as the “search engine,” since the search engine 150 identifies the search results 145 in response to the user-submitted query 105.

In some implementations, the search system 130 can include many computing devices for implementing the functionality of the search system 130. The search system 130 can process the received queries and generate the search results by executing software on the computing devices in order to perform the functions of the search system 130.

Referring to FIG. 1, during state (A), a user of the client device 110 enters original query terms 115 for the original query 105, and the client device 110 communicates the original query 105 to the search system 130 over the network 120. For example, the user can submit the original query 105 by initiating a search dialogue on the client device 110, speaking or typing the original query terms 115 of the original query 105, and then pressing a search initiation button or control on the client device 110. The client device 110 formulates the original query 105 (e.g., by specifying search parameters). The client device 110 transmits the original query 105 over the network 120 to the search system 130.

Although this specification refers to the query 105 as an “original” or an “initial” query, such reference is merely intended to distinguish this query from other queries, such as the revised queries that are described below. The designation of the original query 105 as “original” is not intended to require the original query 105 to be the first query that is entered by the user, or to be a query that is manually entered. For example, the original query 105 can be the second or subsequent query entered by the user. In another example, the original query 105 can be automatically derived (e.g., by the query reviser engine 170). In another example, the original query 105 can be modified based on prior queries entered by the user, location information, and the like.

During state (B), the search system front-end 140 receives the original query 105 and communicates the original query 105 to the query reviser engine 170. The query reviser engine 170 can generate one or more revised queries 135 based on the substance of the original query 105. In some implementations, the query reviser engine 170 generates a revised query by adding terms to the original query 105 using substitute terms 125 for terms in the original query 105. In other implementations, the query reviser engine 170 generates a revised query by substituting the substitute terms 125 for the corresponding terms of the original query 105. The query reviser engine 170 can obtain substitute terms 125 for use in revising the original query 105 from the substitute term engine 180.

During state (C), the query reviser engine 170 communicates original query terms 115 of the original query 105 to the substitute term engine 180. The substitute term engine 180 can use substitution rules included in the substitution rules database 185 to determine one or more substitute terms 125 for one or more of the original query terms 115 of the original query 105.

The substitute term engine 180 communicates substitute terms 125 to the query reviser engine 170 during state (D). The query reviser engine 170 generates one or more revised queries 135 by adding substitute terms 125 to the original query 105. In addition, the query reviser engine 170 can generate one or more revised queries 135 by substituting certain terms of the original query 105.

The query reviser engine 170 communicates the one or more revised queries 135 to the search system front-end 140 during state (E). The search system front-end 140 communicates the original query 105 along with the one or more revised queries 135 to the search engine 150 as all queries 137 during state (F). The search engine 150 generates search results 145 that it identifies as being responsive to the original query 105 and/or the one or more revised queries 135. The search engine 150 can identify search results 145 for each query using an index database 160 that stores indexed resources, e.g., web pages, images, or news articles on the Internet. The search engine 150 can compute scores for each of the identified search results 145 using a scoring engine that computes a score for an indexed resource using terms of the original query 105 and substitute terms 125 of terms in the original query 105. The search engine 150 can combine and rank the identified search results 145 by score and communicate the search results 145 to the search system front-end 140 during state (G).

The search system front-end 140 generates a search results page 155 that identifies the search results 145. For example, each of the search results 145 can include, but are not limited to, titles, text snippets, images, links, reviews, or other information. The original query terms 115 or the substitute terms 125 that appear in the search results 145 can be formatted in a particular way (e.g., in bold print and/or italicized print). For example, the search system front-end 140 transmits a document that includes markup language (e.g., HyperText Markup Language or eXtensible Markup Language) for the search results page 155 to the client device 110 over the network 120 at state (H). The client device 110 reads the document (e.g., using a web browser) in order to display the search results page 155 on display device 118. The client device 110 can display the original query terms 115 of the original query 105 in a query box (or “search box”), located, for example, on the top of the search results page 155. In addition, the client device 110 can display the search results 145 in a search results box, for example, located on the left-hand side of the search results page 155.

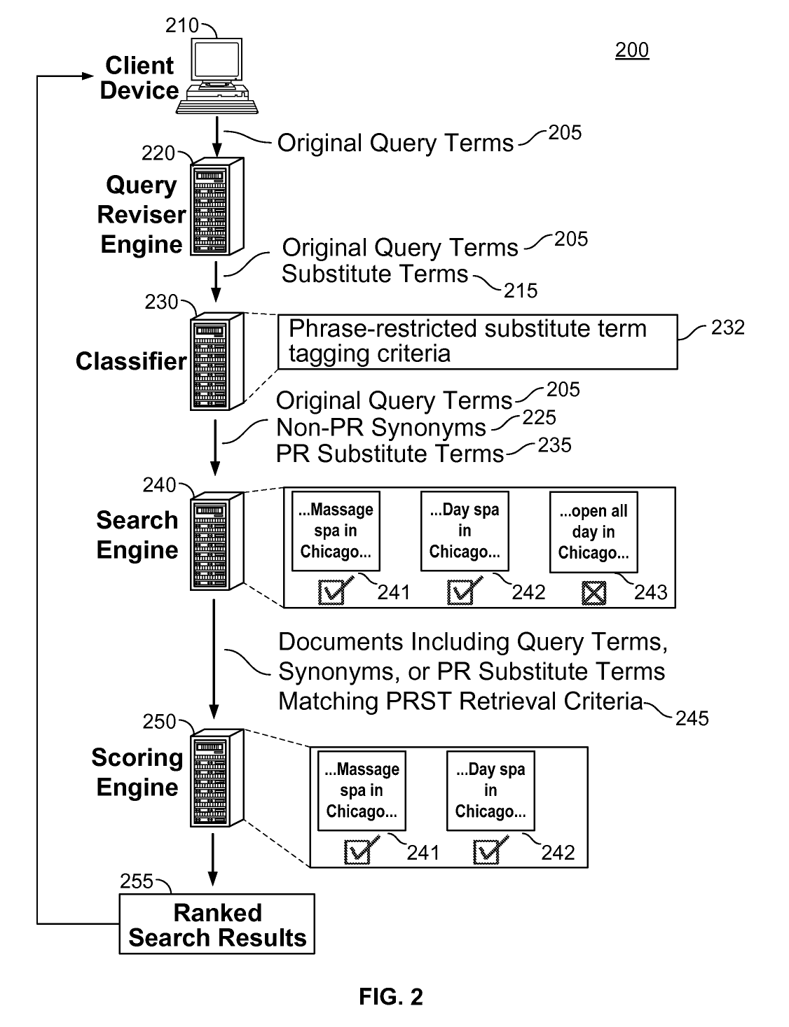

FIG. 2 is a diagram of an example system 200 that uses retrieval criteria for phrase-restricted substitute terms to generate search results. The system 200 includes a client device 210, a query reviser engine 220, a classifier 230, a search engine 240, and a scoring engine 250. The entities illustrated in FIG. 2 can, for example, be implemented as part of the system illustrated in FIG. 1.

In general, a query including one or more original query terms 205 is received from a client device, and the query reviser engine 220 can identify one or more substitute terms 215 of the original query terms 205.

As used by this specification, the substitution rule notation “A->B” indicates that, according to a particular substitution rule, the term “B” is considered to be a substitute term for the term “A.” Using this rule, the query reviser engine 220 may generate revised queries by adding term “B” to an original query, by substituting term “B” for term “A” in the original query, or by performing other query revision techniques.

The substitute terms 215 can be differentiated into different classes or types of substitute terms by a classifier 230. In some examples, the classifier 230 can classify substitute terms 215 as either phrase-restricted substitute terms 225 or non-phrase-restricted substitute terms 235 based on one or more phrase-restricted substitute term criteria 232. Whether the search engine 240 selects a document to be scored that includes a phrase-restricted substitute term can depend on whether one or more other terms co-occur with or adjacent to the phrase-restricted substitute term in the document.

The search engine 240 can identify search results 245 using the substitute terms 215 of the original query terms 205. To identify search results 245, the search engine 240 may, in some example implementations, retrieve indexed documents that include the original query terms 205, substitute terms 215 of the original query terms 205, or both.

The search engine 240 can use retrieval criteria for documents that include phrase-restricted substitute terms that are different than retrieval criteria for documents that include query terms and other non-phrase-restricted substitute terms. If a document (1) does not include a first query term or a non-phrase-restricted substitute term identified for the first query term, but (2) does include a phrase-restricted substitute term identified for the first query term, the search engine 240 can select the document to be scored only if the phrase-restricted substitute term occurs in the document adjacent to a second query term that was adjacent to the first query term in original search query. The retrieval criteria can also require that documents include one or more other query terms or corresponding substitute terms.

For documents that include query terms or non-phrase-restricted substitute terms for absent query terms, the search engine 240 can apply different retrieval criteria. In some implementations, the search engine 240 can select a document to be scored if the document includes every query term or corresponding substitute term anywhere in the document. In some other implementations, the search engine 240 can select a document to be scored if the document includes any query term or corresponding substitute term anywhere in the document.

For example, for the search query “massage spa,” the query reviser engine 220 can identify a substitute term “day” for the query term “massage.” The classifier 230 can determine that “day” is a phrase-restricted substitute term of “massage.” The search engine 240 can then receive the original query terms “massage spa” and the phrase-restricted substitute term “day” for the original query term “massage.”

The search engine 240 can consider a first candidate indexed document 241 that includes the text “Massage spa in Chicago.” Because the document 241 includes both original query terms, the search engine 240 can apply the second retrieval criteria. The search engine 240 can determine that the document 241 satisfies the second retrieval criteria by including both original query terms. Therefore, the search engine 240 can select the document 241 to be scored by including the document 241 in search results 245 passed on to scoring engine 250.

The search engine 240 can consider a second candidate indexed document 242 that includes the text “Day spa in Chicago.” Because the document 242 (1) does not include a query term, i.e. “massage,” or a non-phrase-restricted substitute term for “massage,” but (2) includes a phrase-restricted substitute term for the absent query term, i.e. “day” for “massage,” the search engine 240 can apply the first retrieval criteria. In other words, the search engine 240 can select the document 242 to be scored only if the phrase-restricted substitute term occurs in the document adjacent to a second query term that was adjacent in the query to the original query term that generated the phrase-restricted substitute term. The phrase-restricted substitute term “day” was identified for the query term “massage,” which occurred in the original query adjacent to “spa.” In the document 242, “day” also occurs adjacent to the query term “spa.” Therefore, the search engine 240 can determine that the first retrieval criteria for phrase-restricted substitute terms are satisfied, and the search engine 240 can select the document 242 for to be scored.

The search engine 240 can consider a third candidate indexed document 243 that includes the text “open all day in Chicago.” Because the document 243 (1) does not include a query term, i.e. “massage,” or a non-phrase-restricted substitute term for “massage,” but (2) includes a phrase-restricted substitute term for the absent query term, i.e. “day” for “massage,” the search engine 240 can apply the first retrieval criteria. For the document 243, the phrase-restricted substitute term “day” was identified for query term “massage,” which occurred in the original query adjacent to “spa.” However, in the document 243, “day” does not occur in the document 243 adjacent to the query term “spa.” Therefore, the search engine 240 can determine that the first retrieval criteria for phrase-restricted substitute terms is not satisfied, and the search engine 240 does not select the document 243 for scoring.

The scoring engine 250 receives search results 245 and then uses one or more scoring models to assign a score to each document identified by the search results 245, i.e. only documents 241 and 242. One or more documents selected for scoring by scoring engine 250 can then be provided as a set of ranked search results 255 back to client device 210. Some documents that are selected for scoring 245, i.e. documents that satisfy the first or second retrieval criteria, may not be included in the final set of ranked search results 255.

In an alternative implementation, the system 200 can retrieve and score all documents matching the second retrieval criteria. However, before providing search results back to the client device 210, the scoring engine 250 can filter out search results identifying documents that would have been subject to the first retrieval criteria but do not meet the first retrieval criteria. For example, the scoring engine 250 can receive and score document 243 but then filter document 243 out of the ranked list of search results 255. In another alternative implementation, the system can retrieve document 243 but filter out document 243 before being forwarded to the scoring engine 250.

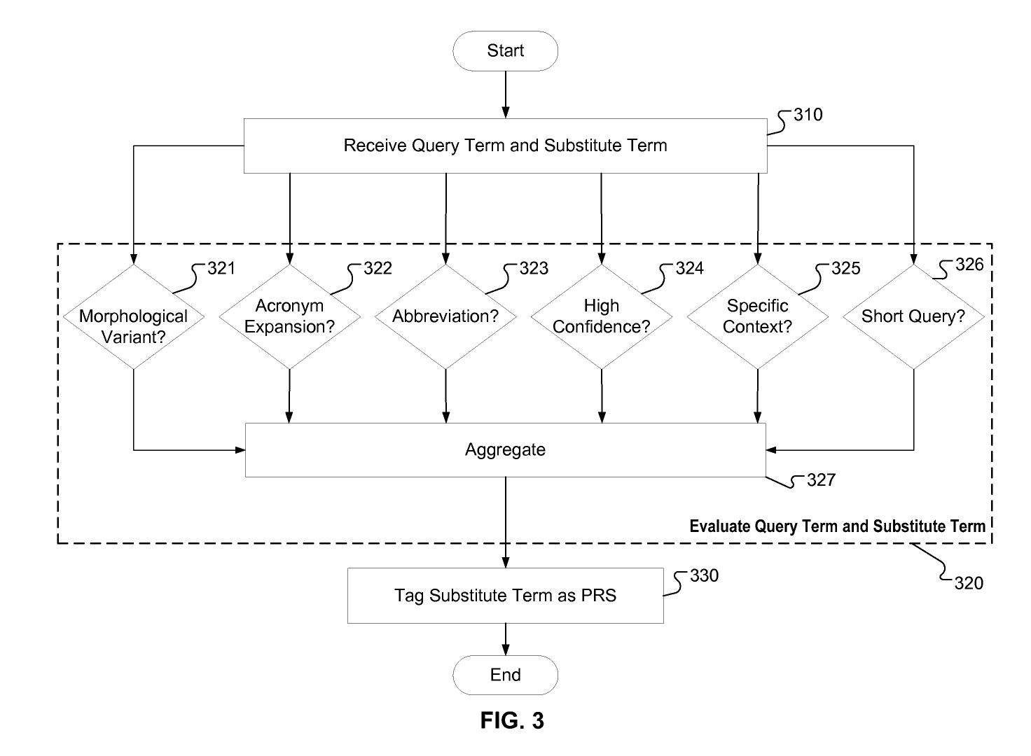

FIG. 3 is a flow chart of an example process 300 for classifying substitute terms as phrase-restricted substitute terms or as non-phrase-restricted substitute terms. In general, the process 300 uses multiple criteria to determine whether a substitute term for a query term should be classified as a phrase-restricted substitute term. The process will be described as being performed by a computer system comprising one or more computers, for example, the search system shown in FIG. 1.

The system receives a query term and a substitute term of the query term (310).

The system evaluates the query term and the substitute term (320). The system can use one or more criteria, e.g., criteria 321-326, as signals in order to classify the substitute term as a phrase-restricted substitute term. In general, classifying a substitute term as a phrase-restricted substitute term indicates that the substitute term's occurrence in a document should be evaluated for consistency with the original query term's occurrence in the query. Accordingly, the occurrence of a phrase-restricted substitute term in a document in relation to other query terms in the document will be taken into account during retrieval.

In contrast, non-phrase-restricted substitute terms may be reliable such that their occurrence in a document in relation to query terms or other substitute terms is less significant or disregarded during retrieval.

Some of the criteria used in classifying a substitute term as a phrase-restricted substitute term depend on the particular type of substitute term being evaluated. A substitute term engine that generates substitution rules can tag or otherwise designate a substitution rule as being of a particular type (e.g. an abbreviation or a morphological variant). When a query reviser engine generates a revised query by identifying substitute terms for query terms, the identified substitute terms can be tagged or designated according to the corresponding designation of the substitution rule used to generate the substitute term.

The system can determine whether the query term and the substitute term are morphological variants (321). The substitute term can, for example, be tagged as a morphological variant substitute term by a query reviser engine. Morphological variants include substitute terms that are variants of the query term in tense (e.g. “run”->“ran”), number (plural or singular, e.g. “cup”->“cups”), past participle constructions (e.g. “theme”->“themed”), present participle constructions (e.g. “run”->“running”), adverbial constructions (e.g. “poor”->“poorly”), or according to other grammatical rules.

Morphological variants can also include terms that share a same stem, terms in which one term is a spelling correction of the other, or terms that that have an edit distance that satisfies a threshold. The occurrence in documents of substitute terms that are morphological variants of query terms tend to be consistent with occurrences of the original query terms in queries regardless of the occurrence of other query terms or other substitute terms. Therefore, a substitute term being a morphological variant is a negative signal for classifying the substitute term as a phrase-restricted substitute term. In some implementations, if a substitute term is a morphological variant of a query term, the substitute term is not classified as a phrase-restricted substitute term.

The system can also determine whether the query term is an acronym for the substitute term and vice versa (322). The substitute term can, for example, be tagged as an acronym substitute term by a query reviser engine. For example, a substitute term “FAQ” for the query term “frequently asked questions” can be tagged as an acronym substitute term. Because acronyms of terms can have essentially the same meaning regardless of the occurrence of other query terms or other substitute terms, occurrences of acronyms in documents tend to be consistent with occurrences of corresponding query terms in queries. Therefore, a substitute term or query term being an acronym of the other is a negative signal for classifying the substitute term as a phrase-restricted substitute term. In some implementations, if the query term is an acronym of the substitute term (or vice versa), the substitute term is not classified as a phrase-restricted substitute term.

The system can also determine whether the query term is an abbreviation for the substitute term and vice versa (323). The substitute term can, for example, be tagged as an abbreviation substitute term by a query reviser engine. For example, if the query term is “dept” and the substitute term is “department,” the system can determine that the query term is an abbreviation for the substitute term. Because abbreviations of terms can have essentially the same meaning regardless of the occurrence of other query terms or other substitute terms, occurrences of abbreviations in documents tend to be consistent with occurrences of corresponding query terms in queries. Therefore, a substitute term or query term being an abbreviation of the other is a negative signal for classifying the substitute term as a phrase-restricted substitute term. In some implementations, if the query term is an abbreviation for the substitute term (or vice versa), the substitute term is not classified as a phrase-restricted substitute term.

The system can determine whether the substitution rule that generated the substitute term has a high confidence value (324). Each substitution rule associated with the query term and substitute term can have an associated confidence value. If the confidence value for a particular substitution rule satisfies a threshold, the system can determine that the substitution rule has a high confidence. Substitution rules without a high confidence value can indicate that in some situations or contexts, a substitute term may have a different meaning than a particular query term. Therefore, a substitute term not having a high confidence value is a positive signal for classifying the substitute term as a phrase-restricted substitute term, so that the substitute term's occurrence in documents in relation to other query terms or other substitute terms is taken into account during scoring.

In contrast, a substitute term with a high confidence value can indicate that the substitute term is a reliable substitution for the query term regardless of other query terms or other substitute terms. In some implementations, if the substitute term was generated with a substitution rule having a high confidence value, the substitute term is not classified as a phrase-restricted substitute term.

The system can determine whether the substitute term was generated using a general context substitution rule or a specific context substitution rule (325). The substitution rule “car->auto (:dealer)” is a specific context substitution rule which specifies that “auto” is a substitute term for “car” only when “car” is followed by “dealer” in the query. A specific context substitution rule indicates that the substitute term is a substitute term for the query term only if particular other terms appear in the query along with the query term. Therefore, the occurrence of a substitute term in a specific context in a document that is consistent with the context of the original query term in can be considered more significant during scoring.

Accordingly, a substitute term being generated by a specific context substitution rule is a positive signal for classifying the substitute term as a phrase-restricted substitute term. In some implementations, if the substitute term was generated using a general context substitution rule (and not with a specific context substitution rule), the substitute term is not classified as a phrase-restricted substitute term.

The system can determine whether the query was a short query (326). The system can count the number of terms in the original query and compare the number of terms to a threshold. If the number of terms satisfies a threshold, e.g. 2, 4, or 5 terms, the system can determine that the query is a short query. Short queries are generally more prone to having ambiguous meanings. Therefore, a substitute term generated from a short query is a positive signal for classifying a classifying the substitute term as a phrase restricted substitute term.

The system can also use signals other than those shown in FIG. 3 in classifying a substitute term as a phrase-restricted substitute term. For example, the system can determine that the substitute term is a proper name and that the query term is not a proper name (e.g. “tim”->“time”) and use proper names as a positive signal for the substitute term being a phrase-restricted substitute term. The system can also classify the query term and substitute term by parts of speech and designate some parts of speech (e.g. verbs) as a positive signal for the substitute term being a phrase-restricted substitute term. Other signals can optionally be used.

The system aggregates the signals to determine whether the substitute term should be classified as a phrase-restricted substitute term (327). For example, the system can apply a weight to each signal and compare a weighted sum of the signals to a threshold. If the sum satisfies the threshold, the system can classify the substitute term as a phrase-restricted substitute term. In some implementations, if any of the criteria are satisfied (e.g. the query term is an abbreviation), the substitute term is classified as a non-phrase-restricted substitute term.

The system tags the substitute term as a phrase-restricted substitute term (330). Tagging the substitute term as a phrase-restricted indicates to a scoring engine that the occurrences of the substitute term in documents should be considered during document retrieval. The system can use any appropriate annotation to designate the substitute term as a phrase-restricted substitute term for use by a scoring engine. In some implementations, the system can tag the substitute term by designating one or more of the other query terms that must occur with the substitute term for a document to be selected to be scored. For example for the query term “massage,” the system can tag the substitute term “day” with “spa.”

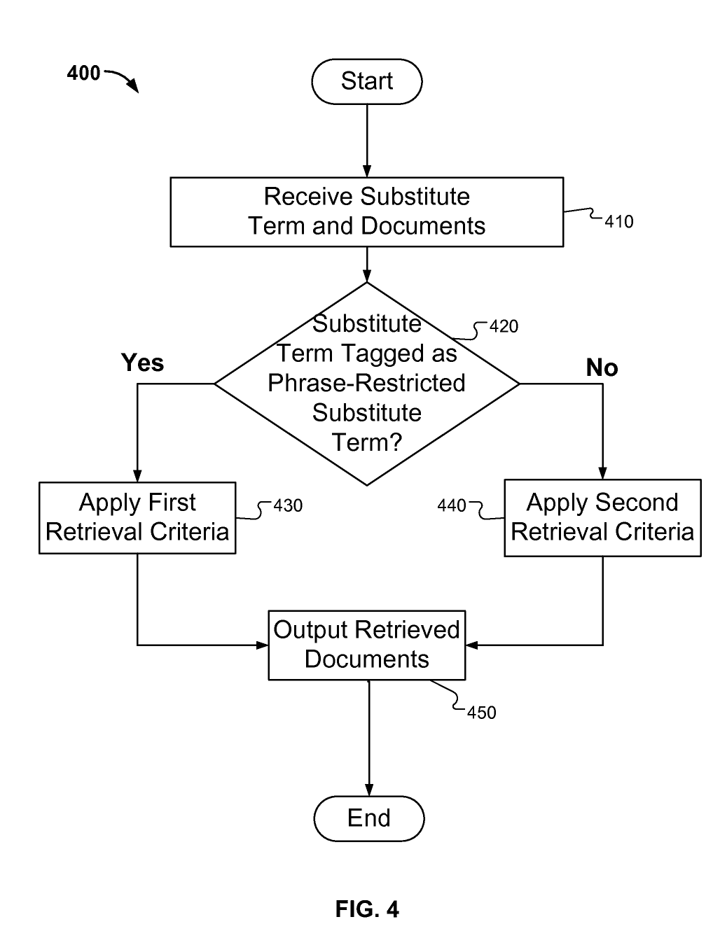

FIG. 4 is a flow chart of an example process 400 for retrieving a document identified using a search query revised to include a substitute term of a query term in the search query. The process 400 will be described as being performed by a search engine, for example, the search engine of FIG. 2. In general, the search engine determines whether to select a document to be scored according to appropriate retrieval criteria the document.

The search engine receives a substitute term of a query term and one or more documents (410). The search engine determines whether the substitute term is tagged as a phrase-restricted substitute term (420).

If the substitute term is tagged as a phrase-restricted substitute term, the search engine applies first retrieval criteria (430). If the query term does not occur in the document, the first retrieval criteria can require the phrase-restricted substitute term in the document to occur adjacent to an original query term in order for the document to be selected to be scored. In some implementations, the first retrieval criteria requires the phrase-restricted substitute term, which was identified for a first query term that was adjacent to a second query term in the query, to occur adjacent to the second query term in the document. The first retrieval criteria can also require the phrase-restricted substitute term to appear to the left or right of the second query term in the document to match the relative position of the first query term and second query term in the query. In some implementations, the first retrieval criteria requires the phrase-restricted substitute term to occur adjacent to the second query term only if neither the query term nor any other non-phrase-restricted substitute terms for the query term occur in the document.

The first retrieval criteria can also further require that each query term or a corresponding substitute term occur in the document for the document to be selected to be scored. If, for a particular absent query term, only a phrase-restricted substitute term occurs in the document, the first retrieval criteria can require that the phrase-restricted substitute term occur adjacent to a second query term. Otherwise, the document is not selected to be scored.

If the substitute term is not tagged as a phrase-restricted substitute term, the search engine applies a second retrieval criteria (440). In some implementations, the second retrieval criteria is the same retrieval criteria used for query terms. For example, the search engine can require all query terms or corresponding substitute terms to occur in the document or can require any query term or corresponding substitute term to occur in the document.

In some implementations, when retrieving documents the search engine traverses a posting list corresponding to each query term and each identified substitute term. A posting list is a list of documents in which each document includes a particular term. The search engine can retrieve documents by scanning a particular posting list and applying either the first or second retrieval criteria to each document. If a substitute term is tagged as a phrase-restricted substitute term, the search engine can determine to use the first retrieval criteria for every document on a posting list corresponding to the phrase-restricted substitute term. In other words, the search engine can make the determination as to whether to use the first or second retrieval criteria only once, and before scanning of the posting list commences.

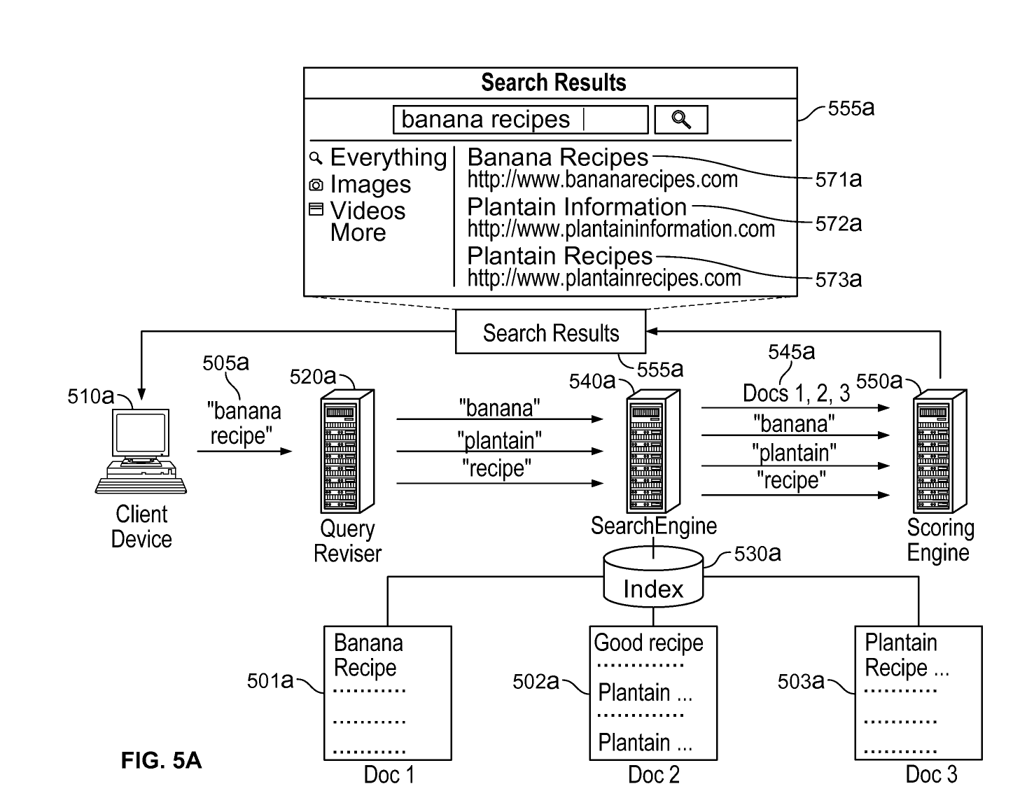

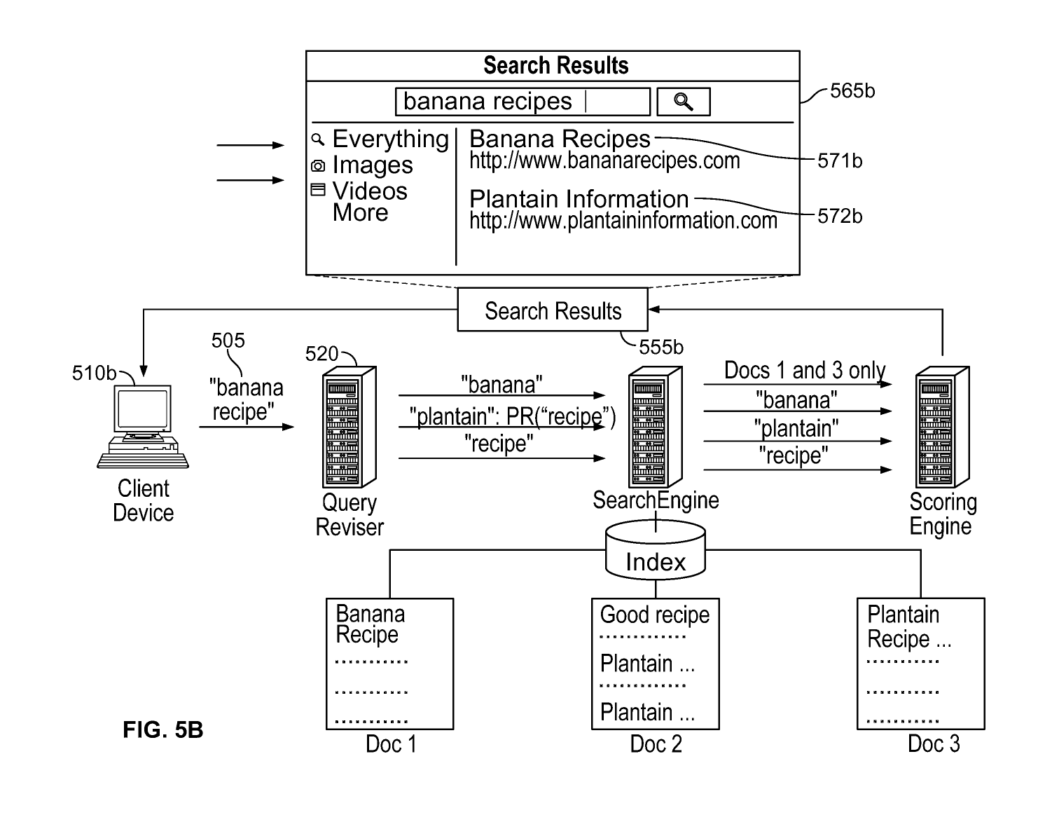

FIG. 5A illustrates retrieval of search results using example retrieval criteria that does not account for phrase-restricted substitute terms. A query 505a is received from a client device 510a. A query reviser engine 520a generates a substitute term “plantain” for the query term “banana.”

A search engine 540a identifies three example documents 501a, 502a, and 503a using the query terms “banana” and “recipe” as well as the substitute term “plantain”. The search engine 540a identifies the documents with retrieval criteria that does not account for phrase-restricted substitute terms. Search results 555a ranked by score are provided back to the client device as, for example, a search results page 565a.

Documents 501a, 502a, and 503a are selected for scoring because each document includes either all query terms or corresponding substitute terms. In other words, document 501a includes both original query terms, “banana” and “recipe”; and documents 502a and 503a include the substitute term “plaintain” for “banana” and the original query term “recipe.”

FIG. 5B illustrates retrieval of search results using example retrieval criteria that accounts for phrase-restricted substitute terms. The search engine 540b considers documents 501b, 502b, and 503b for retrieval in response to query terms “banana” and “recipe” and substitute term “plantain.” However, in FIG. 5B, the substitute term “plantain” is tagged as a phrase-restricted substitute term. The term “plantain” is tagged “PR(‘recipe’)”, indicating that “plantain” is phrase-restricted to “recipe” for retrieval. The search engine 550b will accordingly use different retrieval criteria to account for the phrase-restricted substitute term “plantain.”

Using the retrieval criteria for phrase-restricted substitute terms, the search engine will not select documents 501b, 502b, and 503b for scoring if the phrase-restricted substitute term “plaintain” in the document does not meet the phrase-restricted substitute term criteria. For example, occurrences of phrase-restricted substitute term “plantain” in document 502b do not appear adjacent to the original query term “recipe.” Therefore, search engine 540b can demote the computed score for document 502b accordingly.

Document 503b, on the other hand, includes an occurrence of the phrase-restricted substitute term “plantain” that occurs adjacent to the query term “recipe,” an indication that the phrase-restricted substitute term's occurrence in document 503b is more consistent with the occurrence of the original query term in the query than the occurrence of the phrase-restricted substitute term in document 502b. Therefore, the search engine 540b can select document 503b and not document 502b to be scored. As a result, the list of ranked search results 555b will be altered and a search result 572b corresponding to document 502b will not appear on search results page 565b.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving (i) a search query that includes a first query term and an adjacent, second query term, and (ii) a substitute term for the first query term;
determining that the substitute term is included among a proper subset of terms that are indicated as synonyms of the first query term;
determining that a web page does not include the first query term; and
based on determining that the substitute term is included among the proper subset of terms that are indicated as synonyms of the first query term and determining that the web page does not include the first query term, selecting the web page to be scored only if the substitute term occurs adjacent to the second query term in the web page.

2. The method of claim 1, comprising:
determining that the web page does not include any other substitute term for the first query term,
wherein selecting the web page to be scored is further based on determining that the web page does not include any other substitute term for the first query term.

3. The method of claim 1, wherein determining that the substitute term is included among the proper subset of terms that are indicated as synonyms of the first query term comprises determining that the first query term and the substitute term are not morphological variants.

4. The method of claim 1, wherein determining that the substitute term is included among the proper subset of terms that are indicated as synonyms of the first query term comprises determining that the first query term and the substitute term are not abbreviation or acronym variants.

5. The method of claim 1, wherein determining that the substitute term is included among the proper subset of terms that are indicated as synonyms of the first query term comprises:
identifying a substitution rule used to generate the substitute term and a confidence value associated with the substitution rule; and
determining that the confidence value associated with the substitution rule does not satisfy a threshold.

6. The method of claim 1, wherein determining that the substitute term is included among the proper subset of terms that are indicated as synonyms of the first query term comprises determining that the substitute term was identified using a specific-context substitution rule.

7. The method of claim 1, wherein determining that the substitute term is included among the proper subset of terms that are indicated as synonyms for the first query term comprises:
determining a number of terms in the search query, and
determining that the number of terms in the search query satisfies a threshold.

8. The method of claim 1, wherein selecting the web page to be scored only if the substitute term occurs adjacent to the second query term in the web page comprises:
identifying a plurality of web pages that include the substitute term; and
determining, for each identified web page, that the substitute term occurs adjacent to the second query term in the web page.

9. The method of claim 8, comprising:
determining a score for each of the identified web pages in which the substitute term occurs adjacent to the second query term in the web page; and
ranking the identified web pages in which the substitute term occurs adjacent to the second query term in the web page by score.

10. A system comprising:
one or more computers and one or more storage devices storing instructions that are operable, when executed by the one or more computers, to cause the one or more computers to perform operations comprising:
receiving (i) a search query that includes a first query term and an adjacent, second query term, and (ii) a substitute term for the first query term;
determining that the substitute term is included among a proper subset of terms that are indicated as synonyms of the first query term;
determining that a web page does not include the first query term; and
based on determining that the substitute term is included among the proper subset of terms that are indicated as synonyms of the first query term and determining that the web page does not include the first query term, selecting the web page to be scored only if the substitute term occurs adjacent to the second query term in the web page.

11. The system of claim 10, wherein the operations comprise:
determining that the web page does not include any other substitute term for the first query term,
wherein selecting the web page to be scored is further based on determining that the web page does not include any other substitute term for the first query term.

12. The system of claim 10, wherein determining that the substitute term is included among the proper subset of terms that are indicated as synonyms of the first query term comprises determining that the first query term and the substitute term are not morphological variants.

13. The system of claim 10, wherein determining that the substitute term is included among the proper subset of terms that are indicated as synonyms of the first query term comprises determining that the first query term and the substitute term are not abbreviation or acronym variants.

14. The system of claim 10, wherein determining that the substitute term is included among the proper subset of terms that are indicated as synonyms of the first query term comprises:
identifying a substitution rule used to generate the substitute term and a confidence value associated with the substitution rule; and
determining that the confidence value associated with the substitution rule does not satisfy a threshold.

15. The system of claim 10, wherein determining that the substitute term is included among the proper subset of terms that are indicated as synonyms of the first query term comprises determining that the substitute term was identified using a specific-context substitution rule.

16. The system of claim 10, wherein determining that the substitute term is included among the proper subset of terms that are indicated as synonyms for the first query term comprises:
determining a number of terms in the search query, and
determining that the number of terms in the search query satisfies a threshold.

17. The system of claim 10, wherein selecting the web page to be scored only if the substitute term occurs adjacent to the second query term in the web page comprises:
identifying a plurality of web pages that include the substitute term; and
determining, for each identified web page, that the substitute term occurs adjacent to the second query term in the web page.

18. The system of claim 17, wherein the operations comprise:
determining a score for each of the identified web pages in which the substitute term occurs adjacent to the second query term in the web page; and
ranking the identified web pages in which the substitute term occurs adjacent to the second query term in the web page by score.

19. A computer-implemented method comprising:
receiving (i) a search query that includes a first query term and an adjacent, second query term, and (ii) a substitute term for the first query term;
determining that the substitute term is designated as a phrase-restricted substitute term of the first query term;
in response to determining that the substitute term is designated as a phrase-restricted substitute term of the first query term, determining that, in a web page that has been identified as responsive to the search query and that does not include the first query term, the substitute term occurs adjacent to the second query term in the web page; and
selecting the web page to be scored in relation to the search query only after determining that, in the web page that has been identified as responsive to the search query and that does not include the first query term, the substitute term occurs adjacent to the second query term in the web page.

20. The method of claim 19, comprising:
determining that the web page does not include any other substitute term for the first query term,
wherein selecting the web page to be scored in relation to the search query is further based on determining that the web page does not include any other substitute term for the first query term.

21. The method of claim 19, wherein selecting the web page to be scored in relation to the search query only after determining that, in the web page that has been identified as responsive to the search query and that does not include the first query term, the substitute term occurs adjacent to the second query term in the web page comprises:
identifying a plurality of web pages that include the substitute term; and
determining, for each identified web page, that the substitute term occurs adjacent to the second query term in the web page.

22. The method of claim 21, comprising:
determining a score for each of the identified web pages in which the substitute term occurs adjacent to the second query term in the web page; and
ranking the identified web pages in which the substitute term occurs adjacent to the second query term in the web page by score.

23. The method of claim 1, wherein the proper subset of terms that are indicated as synonyms of the first query term includes terms that are not indicated as highly reliable synonyms of the first query term.

24. The method of claim 19, wherein a phrase-restricted substitute term of the first query term is a term that is not indicated as a highly reliable synonym of the first query term.
